(19) United States
(12) Patent Application Publication
(10) Pub. No.: US 2026/0005619 A1
(43) Pub. Date: Jan. 1, 2026

(54) POWER CONTROL CIRCUIT AND POWER SUPPLY DEVICE

(71) Applicant: RIGOL TECHNOLOGIES CO., LTD., Suzhou (CN)

(72) Inventors: Hongkai FENG, Suzhou (CN); Yue WANG, Suzhou (CN)

(21) Appl. No.: 19/250,748

(22) Filed: Jun. 26, 2025

(30) Foreign Application Priority Data
Jun. 28, 2024 (CN) 202410865433.7

(51) Int. Cl. H02M 3/337

(52) U.S. Cl. CPC H02M 3/3376

(57) ABSTRACT

An embodiment of the present disclosure provides a power control circuit and a power supply device. The circuit is provided with a feedback module and a control module. A first end of the feedback module is connected to a primary side circuit of a push-pull switching power, a second end of the feedback module is connected to the control module, and the feedback module is configured to generate a corresponding feedback signal according to an electrical signal of the primary side circuit of the push-pull switching power. The control module is respectively connected to control ends of two switching tubes in the primary side circuit of the push-pull switching power, and the control module is configured to control on-off states of the two switching tubes according to a preset power voltage and the feedback signal, so as to adjust output electrical signals of power output channels.

### CROSS-REFERENCE TO RELATED APPLICATION

The present disclosure claims priority to Chinese patent application No. 202410865433.7, filed on Jun. 28, 2024, entitled “POWER CONTROL CIRCUIT AND POWER SUPPLY DEVICE”, which is incorporated herein by reference in its entirety.

### TECHNICAL FIELD

The present disclosure relates to the field of power supply, and particularly to a power control circuit and a power supply device.

### BACKGROUND

The push-pull switching power has the advantages of high output efficiency and high working efficiency, is suitable for various application scenarios, and thus it is deeply trusted by users.

The open-loop controlled push-pull switching power has a simple control circuit, lower switching noise, and a relatively stable working state, facilitating achieving multi-channel output. However, the open-loop control method makes the output voltage of the push-pull switching power change with the input voltage, limiting the use scenarios of the circuit.

To ensure that the output voltage remains stable when changing with the input voltage, one channel output of a multi-output isolated push-pull power is used as a feedback loop to perform feedback control on the output voltage of the power in the prior art. However, such a feedback method changes with the load current in each output channel, which may cause an imbalance in multi-channel output voltages, and thus affect the power supply quality of the power. If a voltage stabilizing circuit is additionally added, the circuit costs will be high, the circuit complexity will be increased, the output noise performance will be reduced, and the advantages of this circuit structure will be weakened.

### SUMMARY

The present disclosure provides a power control circuit and a power supply device to improve the power supply quality of the power without increasing circuit costs and complexity.

According to an aspect of the present disclosure, a power control circuit is provided, applied to control a push-pull switching power, where a secondary side circuit of the push-pull switching power is provided with a plurality of power output channels; and
the power control circuit includes: a feedback module and a control module,
where a first end of the feedback module is connected to a primary side circuit of the push-pull switching power, a second end of the feedback module is connected to the control module, and the feedback module is configured to generate a corresponding feedback signal according to an electrical signal of the primary side circuit of the push-pull switching power; and
the control module is respectively connected to control ends of two switching tubes in the primary side circuit of the push-pull switching power, and the control module is configured to control on-off states of the two switching tubes according to a preset power voltage and the feedback signal, so as to adjust output electrical signals of the power output channels.

Optionally, the electrical signal of the primary side circuit includes driving signals of the switching tubes;
the first end of the feedback module is connected to a control end of any one switching tube of the switching tubes in the primary side circuit of the push-pull switching power; and the feedback module is configured to generate a corresponding feedback signal according to a duty cycle of the driving signal of the switching tube from the control module.

Optionally, the primary side circuit of the push-pull switching power is provided with an auxiliary sampling winding, where one end of the auxiliary sampling winding is connected to the first end of the feedback module, and the other end of the auxiliary sampling winding is grounded;
the electrical signal of the primary side circuit includes an electrical signal of the auxiliary sampling winding; and
the feedback module is configured to determine a duty cycle of a driving signal of the switching tube from the control module according to the electrical signal of the auxiliary sampling winding, and further generate a corresponding feedback signal according to the duty cycle.

Optionally, the feedback module includes: a signal conversion unit;
where an input end of the signal conversion unit is connected to the first end of the feedback module, an output end of the signal conversion unit is connected to the second end of the feedback module, and the signal conversion unit is configured to generate a corresponding feedback signal according to an electrical signal collected by the first end of the feedback module, where the feedback signal is a digital signal with a high level of a first preset voltage and a low level of 0.

Optionally, the feedback module further includes a voltage division unit, where the voltage division unit is disposed between the output end of the signal conversion unit and the second end of the feedback module, and the voltage division unit is configured to perform an adjustment operation on the feedback signal, so that the feedback signal meets a voltage requirement of the control module.

Optionally, the feedback module further includes a pre-filtering unit, where the pre-filtering unit is disposed between the output end of the signal conversion unit and the second end of the feedback module, and the pre-filtering unit is configured to filter the feedback signal to remove a high-frequency component from the feedback signal.

Optionally, the signal conversion unit includes an inverter or a logic buffer, where a power supply end of the inverter or the logic buffer is connected to a first power supply end, and the inverter or the logic buffer is configured to convert the electrical signal collected by the first end of the feedback module into the digital signal with a high level of the first preset voltage and a low level of 0, where the first preset voltage is provided by the first power supply end.

Optionally, the primary side circuit of the push-pull switching power is powered by a second power supply end; and
voltages provided by the first power supply end and the second power supply end are equal or proportionally related.

According to another aspect of the present disclosure, a power supply device is provided, including the power control circuit and the push-pull switching power described in the first aspect.

The power control circuit and the power supply device provided in the embodiments are provided with a feedback module and a control module. A first end of the feedback module is connected to a primary side circuit of a push-pull switching power, a second end of the feedback module is connected to the control module, and the feedback module is configured to generate a corresponding feedback signal according to an electrical signal of the primary side circuit of the push-pull switching power. The control module is respectively connected to the control ends of two switching tubes in the primary side circuit of the push-pull switching power, and the control module is configured to control on-off states of the two switching tubes according to a preset power voltage and the feedback signal, so as to adjust output electrical signals of power output channels, which achieves the closed-loop feedback control on the push-pull switching power. A feedback signal collection end is disposed in the primary side circuit of the push-pull switching power. This feedback configuration avoids affecting output voltages of the power output channels and a situation of inconsistent voltages in multiple channels, improving the power supply quality of the power without increasing circuit costs and circuit complexity.

It should be understood that the content described in this section is not intended to identify key or essential features of the embodiments of the present disclosure, nor is it intended to limit the scope of the present disclosure. Other features of the present disclosure will be easily understood through the following description.

### BRIEF DESCRIPTION OF THE DRAWINGS

To illustrate the technical solutions in the embodiments of the present disclosure more clearly, the following briefly introduces the drawings required for describing the embodiments. It is obvious that the drawings in the following description only show some embodiments of the present disclosure, and a person of ordinary skill in the art may still obtain other drawings from these drawings without creative efforts.

FIG. 1 is a schematic structural diagram illustrating a power control circuit and a corresponding push-pull switching power provided in an embodiment of the present disclosure;

FIG. 2 is a schematic structural diagram illustrating another power control circuit and a corresponding push-pull switching power provided in an embodiment of the present disclosure;

FIG. 3 is a schematic structural diagram illustrating yet another power control circuit and a corresponding push-pull switching power provided in an embodiment of the present disclosure;

FIG. 4 is a schematic structural diagram illustrating yet another power control circuit and a corresponding push-pull switching power provided in an embodiment of the present disclosure;

FIG. 5 is a schematic diagram illustrating a connection relationship between a first power supply end, a second power supply end, and a power supply source provided in an embodiment of the present disclosure;

FIG. 6 is a schematic diagram illustrating another connection relationship between a first power supply end, a second power supply end, and a power supply source provided in an embodiment of the present disclosure; and

FIG. 7 is a schematic structural diagram illustrating a power supply device provided in an embodiment of the present disclosure.

### DETAILED DESCRIPTION

To enable those skilled in the art to better understand the solutions of the present disclosure, the technical solutions in the embodiments of the present disclosure will be described clearly and completely below in conjunction with the drawings in the embodiments of the present disclosure. Obviously, the described embodiments are only a part of the embodiments of the present disclosure, but not all of the embodiments. Based on the embodiments in the present disclosure, all other embodiments obtained by those of ordinary skill in the art without making creative efforts shall fall within the scope of protection of the present disclosure.

It should be noted that the terms “first,” “second,” etc., in the description, claims, and the above drawings of the present disclosure are used to distinguish similar objects and not necessarily to describe a specific order or sequence. It should be understood that the data used in this manner may be interchanged under appropriate circumstances, so that the embodiments of the present disclosure described herein can be implemented in sequences other than those illustrated or described herein. In addition, the terms “include/comprise,” “have,” and any variations thereof are intended to cover non-exclusive inclusion. For example, a process, method, system, product, or device that includes a series of steps or units is not necessarily limited to those clearly listed steps or units, but may include other steps or units not clearly listed or inherent to such a process, method, product, or device.

As described in the background, to ensure that the output voltage remains stable when changing with the input voltage, the output of one channel of a multi-output isolated push-pull power is used as a feedback loop to perform feedback control on the output voltage of the power in the prior art. However, such a feedback loop causes an imbalance in multi-channel output voltages, which affects the power supply quality of the power. If a voltage stabilizing circuit is additionally added, it will lead to high circuit costs and increased circuit complexity. Through research, the inventors have found that when the output of one channel of a multi-output isolated push-pull power is used as a feedback loop for controlling the output voltage, the output channel used for feedback must ensure that the output inductor works in a continuous conduction mode where the inductor and current are continuous, otherwise the cross-load regulation rate will be too high, which will cause the voltage of other output channels to be too low when they are heavily loaded (also referred to as Continuous Conduction Mode, CCM) during multi-channel output, leading to abnormal working of loads in the other output channels and affecting power supply reliability. In addition, when only one channel output is used for feedback, the remaining output channels cannot achieve true multi-channel voltage stabilization output. Additional circuits (such as magnetic amplifiers, etc.) are required for voltage stabilization control between multiple channels, which greatly increases structural complexity and has limited effectiveness.

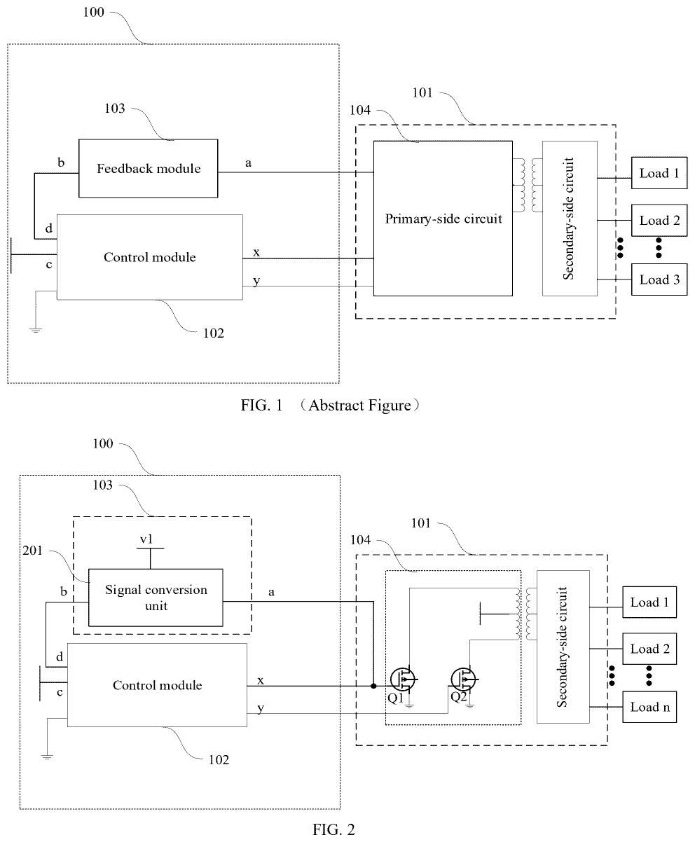

To solve the aforementioned problems, an embodiment of the present disclosure provides a power control circuit, applied to control a push-pull switching power with a plurality of power output channels disposed in a secondary side circuit. FIG. 1 is a schematic structural diagram illustrating a power control circuit and a corresponding push-pull switching power provided in an embodiment of the present disclosure. Referring to FIG. 1, the power control circuit 100 includes a feedback module 103 and a control module 102. A first end a of the feedback module 103 is connected to a primary side circuit 104 of a push-pull switching power 101, a second end b of the feedback module 103 is connected to the control module 102, and the feedback module 103 is configured to generate a corresponding feedback signal according to an electrical signal of the primary side circuit 104 of the push-pull switching power 101. The control module 102 is respectively connected to control ends of two switching tubes in the primary side circuit 104 of the push-pull switching power 101 (prior art, not shown in the figure), and the control module 102 is configured to control on-off states of the two switching tubes according to a preset power voltage and the feedback signal, so as to adjust output electrical signals of power output channels. The control module 102 may include a closed-loop control amplifier circuit and a PWM generation circuit, where the closed-loop control amplifier circuit may be composed of an error amplifier circuit and a loop compensation circuit. The working principle of the control module 102 is as follows: the two input ends of the closed-loop control amplifier circuit are respectively connected to a preset power and the feedback module 103, and are configured to compare and amplify a preset power voltage of the preset power and a feedback signal received from the feedback module 103 to generate a specific control voltage, and transmit the control voltage to the PWM generation circuit to generate a driving signal with a specific duty cycle, thereby controlling the turn-on or turn-off of the two switch tubes.

Specifically, the feedback module 103 is a circuit component in the power control circuit 100 that collects and provides feedback on the electrical signal of the primary side circuit of the push-pull switching power 101. Exemplarily, the feedback module 103 may include a logic circuit capable of implementing a feedback function. For example, the logic circuit may include an inverter, a filter, and a voltage divider. The first end a of the feedback module 103 is a signal collection end, which is connected to the primary side circuit 104 of the push-pull switching power 101 and is configured to acquire the electrical signal of the primary side circuit of the push-pull switching power 101. Exemplarily, the first end a of the feedback module 103 may be connected to a control end of any one switching tube in the primary side circuit of the push-pull switching power 101 to acquire a duty cycle of a driving signal of the switching tube. The feedback module 103 may also be connected to an auxiliary winding of the push-pull switching power 101 to collect an electrical signal of the auxiliary winding, thereby analyzing a duty cycle of a driving signal of the switching tube in the primary-side circuit. The duty cycle may refer to a ratio of on-state time of the switching tube to a switching cycle thereof. The second end b of the feedback module 103 is a feedback end, which is connected to a receiving end for a feedback signal on the control module 102. The feedback module 103 can generate the corresponding feedback signal according to the acquired electrical signal of the primary side circuit of the push-pull switching power 101. Exemplarily, the feedback signal may include duty cycle information of the driving signal of the switching tube.

The control module 102 is a central processing module of the power control circuit 100. It can generate two sets of driving signals according to the preset power voltage and the feedback signal to control the on-off states of the two switching devices in the primary side circuit of the push-pull switching power 101, thereby achieving the adjustment of an output voltage of the push-pull switching power 101. The driving signals may be pulse width modulation signals. Exemplarily, the control module 102 may include a driver chip or a pulse width modulation control chip of the push-pull switching power 101. The driver chip may include components such as a pulse width modulation (PWM) circuit and switching tubes Q1 and Q2, etc., and directly drive a push-pull isolated transformer composed of components such as a primary-side winding and a secondary-side winding, etc. The pulse width modulation control chip can be configured to receive the feedback signal, compare a voltage of the feedback signal with a preset voltage generated internally by the pulse width modulation chip to produce an error signal, generate a PWM wave with an adjustable duty cycle through an internal oscillator and comparator according to the error signal, and allocate the PWM wave to the two switching tubes Q1 and Q2 through the logic circuit to form two alternating driving pulses with logical levels. The control module 102 may be provided with a power supply end c, a feedback end d, and two driving output ends x and y. The power supply ends c of the control module 102 is connected to a preset power, the feedback end is connected to the second end b of feedback module 103, and the driving output ends x and y are respectively connected to the control ends of the corresponding switching tubes in the primary side circuit 104. The preset power connected to the power supply end c of the control module 102 may be a set power, whose potential can indicate the duty cycle of the driving signal output by the control module 102. The control module 102 can determine the duty cycle of a corresponding driving signal according to the feedback signal received by the feedback end d. Since the transformation ratio between the primary-side winding and the secondary-side winding of the push-pull switching power 101 is known, and in a case that a power supply of the push-pull switching power 101 is determined, the duty cycle has a definite correlation with the output voltage of the push-pull switching power 101. Therefore, the control module 102 can adjust the duty cycle of its output driving signal according to the duty cycle to achieve the adjustment and control of the output voltage of the push-pull switching power 101.

The power control circuit provided in the present embodiment is provided with a feedback module and a control module. A first end of the feedback module is connected to a primary side circuit of a push-pull switching power, a second end of the feedback module is connected to the control module, and the feedback module is configured to generate a corresponding feedback signal according to an electrical signal of the primary side circuit of the push-pull switching power. The control module is respectively connected to the control ends of two switching tubes in the primary side circuit of the push-pull switching power, and the control module is configured to control on-off states of the two switching tubes according to a preset power voltage and the feedback signal, so as to adjust output electrical signals of power output channels, achieving the closed-loop feedback control of the push-pull switching power. A feedback signal collection end is disposed at the primary side circuit of the push-pull switching power. This feedback configuration avoids affecting the output voltage of the power output channel and a situation of inconsistent voltages in multiple channels, improving the power supply quality of the power without increasing circuit costs and circuit complexity.

Optionally, FIG. 2 is a schematic structural diagram illustrating another power control circuit and a corresponding push-pull switching power provided in an embodiment of the present disclosure. Based on the aforementioned embodiment and referring to FIG. 2, an electrical signal of a primary side circuit includes driving signals of switching tubes. A first end a of a feedback module 103 is connected to a control end of any one switching tube in the primary side circuit of a push-pull switching power 101. The feedback module 103 is configured to generate a corresponding feedback signal according to a duty cycle of the driving signal of the switching tube from a control module 102.

Specifically, the driving signal of the switching tube refers to a signal provided by control module 102 to the switching tube. The first end a of the feedback module 103 is connected to the control end of any one switching tube of the push-pull switching power 101, allowing it to acquire the driving signal of the switching tube, then determine the duty cycle of the driving signal of the switching tube, and then generate the corresponding feedback signal according to the duty cycle. Exemplarily, if the two switching tubes are a first field-effect transistor Q1 and a second field-effect transistor Q2, respectively, the first end of the feedback module 103 is connected to a gate of any one field-effect transistor.

Continuing with reference to FIG. 2, the feedback module 103 may include a signal conversion unit 201. An input end of the signal conversion unit 201 is connected to the first end a of the feedback module 103, and the output end of the signal conversion unit 201 is connected to a second end b of the feedback module 103. The signal conversion unit 201 is configured to generate a corresponding feedback signal according to the electrical signal collected by the first end a of the feedback module 103, where the feedback signal is a digital signal (also referred to as a logic signal) with a high level of a first preset voltage and a low level of 0.

Specifically, the signal conversion unit 201 refers to a component that converts the electrical signal acquired by the first end of the feedback module 103 into a corresponding logic signal, and the logic signal serves as the feedback signal. The first power supply end v1 is a power supply end for providing power to the signal conversion unit 201. Exemplarily, the signal conversion unit 103 may include an inverter or a logic buffer. A power supply end of the inverter or the logic buffer is connected to the first power supply end v1. The inverter or the logic buffer is configured to convert an electrical signal collected by the first end a of the feedback module 103 into a digital signal with a high level of the first preset voltage and a low level of 0, where the first preset voltage is provided by the first power supply end v1.

In the case where the electrical signal acquired by the first end a of the feedback module 103 is a driving signal of the switching tube in the primary side circuit, the signal conversion unit 201 can adjust an electrical signal, the voltage of which is lower than a preset voltage, in the electrical signals acquired by the first end of the feedback module 103 to the first preset voltage, and adjust an electrical signal, the voltage of which is higher than the preset voltage, in the electrical signals to 0, so that a duty cycle of the feedback signal is the same as or correlated with the duty cycle of the driving signal of the switching tube in the primary side circuit, thereby achieving feedback of the duty cycle of the driving signal to the control module 102. The control module 102 includes an error conversion component that can adjust a duty cycle signal. This error conversion component can compare the duty cycle of the driving signal collected by the feedback module 103 with a preset duty cycle and adjust the output driving signal according to the difference between the two duty cycles to achieve closed-loop control, where the preset duty cycle can be correspondingly determined according to a set value of an output voltage of the push-pull switching power 101. Exemplarily, the control module may include an operational amplifier and a pulse width modulator, where the operational amplifier can be disposed before the pulse width modulator and is configured to amplify or buffer the feedback signal.

In the power control circuit provided in the present embodiment, the first end of the feedback module is connected to the control end of any one switching tube in the primary side circuit of the push-pull switching power to access the driving signal of the switching tube. Signal conversion is performed according to the driving signal to convert it into the logic signal with a low level of 0 and a high level of a first preset voltage. On the basis of transmitting the duty cycle signal, the feedback signal can be recognized by the control module, and is adapted to the control module, facilitating type selection of the control module.

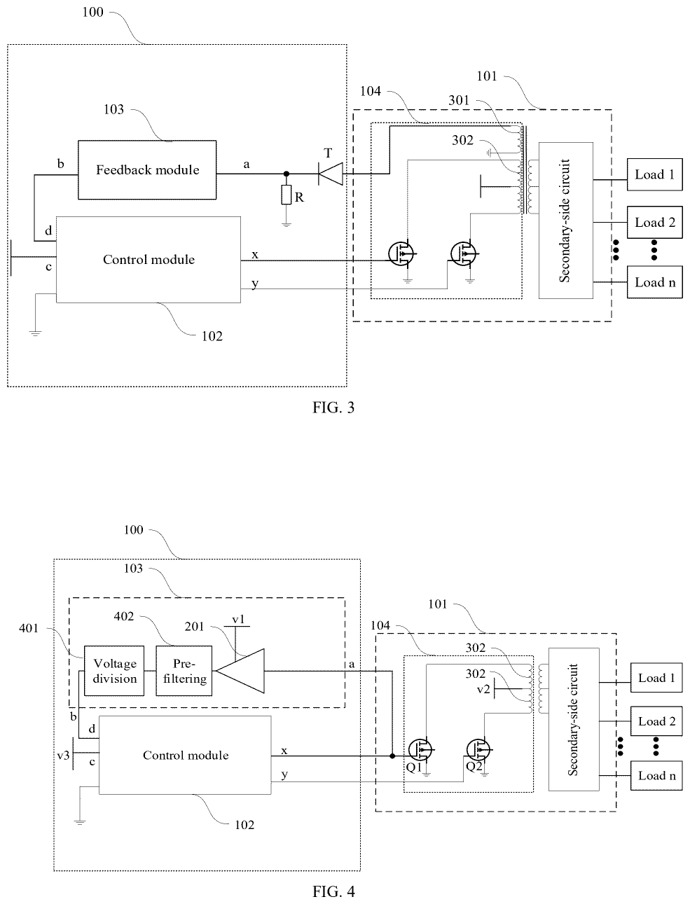

Optionally, FIG. 3 is a schematic structural diagram illustrating yet another power control circuit and a corresponding push-pull switching power provided in an embodiment of the present disclosure. On the basis of the aforementioned embodiments and with reference to FIG. 3, the primary side circuit of the push-pull switching power 101 is provided with an auxiliary sampling winding 301. One end of the auxiliary sampling winding 301 is connected to the first end a of the feedback module 103, and the other end of the auxiliary sampling winding 301 is grounded. The electrical signal of the primary side circuit 104 includes an electrical signal of the auxiliary sampling winding 301. The feedback module 103 is configured to determine a duty cycle of the driving signal according to the electrical signal of the auxiliary sampling winding 301 and then generate a corresponding feedback signal according to the duty cycle.

Specifically, the auxiliary sampling winding 301 refers to a winding disposed in the primary side circuit of the push-pull switching power 101. One end of the winding is grounded, and the other end of the winding is connected to the first end a of the feedback module 103. The electrical signal can be generated in the auxiliary sampling winding according to a change of magnetic flux in a transformer core where it is located. This electrical signal has a certain proportional relationship with the electrical signal in a primary-side winding 302 connected to a switching tube, so it can reflect the duty cycle of the driving signal connected to the switching tube. The feedback module 103 acquires the electrical signal in the auxiliary sampling winding, analyzes and determines the duty cycle of the driving signal of the corresponding switching tube according to this electrical signal, and feeds it back to the control module 102 to achieve feedback control of the push-pull switching power 101. By this feedback method where the auxiliary sampling winding 301 is separately disposed, the feedback module 103 is not directly connected to the control end of the switching tube, on one hand, it achieves electrical isolation between the feedback signal and a driving output end of the control module 102, and in a case that other electrical elements are disposed between the control module 102 and the corresponding switching tube, it can reduce a distortion effect of these electrical elements on the feedback signal, and on the other hand, it makes a signal collected by the feedback module 103 more correlated with the output power of the push-pull switching power 101, thereby improving precision of power control. In addition, the power control circuit 100 may be further provided with a grounding resistor R and an anti-reverse diode (i.e., a reverse polarity protection diode) T, both of which can be configured to rectify the electrical signal output from the primary side circuit 104 of the push-pull switching power 101 to remove a voltage less than an on-state voltage of the anti-reverse diode T (for example, to remove a voltage less than 0). The anti-reverse diode T is disposed between the first end a of the feedback module 103 and the primary side circuit 104 of the push-pull switching power 101 (for example, the auxiliary sampling winding 301). One end of the grounding resistor R is connected to the first end a of the feedback module 103, and the other end of the grounding resistor R is grounded. A resistance value of the grounding resistor R can be adjusted according to the demand of the feedback module 103.

In the power control circuit provided in the present embodiment, one end of the auxiliary sampling winding is connected to the first end of the feedback module, and the other end of the auxiliary sampling winding is grounded. The electrical signal of the primary side circuit includes the electrical signal of the auxiliary sampling winding. The feedback module is configured to determine a duty cycle of the electrical signal in the primary-side winding according to the electrical signal from the auxiliary sampling winding and then generate a corresponding feedback signal according to the duty cycle, thereby achieving signal collection and feedback for the push-pull switching power. The signal of the feedback module is acquired through the auxiliary sampling winding, achieving electrical isolation between the feedback signal and the driving output of the control module, reducing a distortion effect of other electrical elements connected to an output end of the control module on the feedback signal, so that the feedback signal more accurately feed back an actual working state of the push-pull switching power, and it further improves precision of power control.

Optionally, FIG. 4 is a schematic structural diagram illustrating yet another power control circuit and a corresponding push-pull switching power provided in an embodiment of the present disclosure. On the basis of the aforementioned embodiments and with reference to FIG. 4, the feedback module 103 further includes a voltage division unit 401. The voltage division unit 401 is disposed between the output end of the signal conversion unit 201 and the second end b of the feedback module 103. The voltage division unit 401 is configured to perform an adjustment operation on the feedback signal, so that the feedback signal meets a voltage requirement of the control module 102.

The feedback module 103 further includes a pre-filtering unit 402. The pre-filtering unit 402 is disposed between the output end of the signal conversion unit 201 and the second end b of the feedback module 103, and is configured to filter the feedback signal to remove a high-frequency component from the feedback signal.

Specifically, the voltage division unit 401 is a component in the feedback module 103 that performs further voltage adjustment processing on the feedback signal output by the signal conversion unit 20, and can attenuate or amplify the feedback signal. Exemplarily, the voltage division unit 401 may include a resistor with an adjustable resistance value, and its control end may be connected to the control module 102. The control module 102 can adjust the resistance value of the resistor with an adjustable resistance value according to the voltage demand on the feedback signal, so that the feedback module 103 is further adapted to the control module 102, thereby reducing difficulty in selecting a type of the control module 102, and improving adaptedness between various parts of the circuit.

The pre-filtering unit 402 may include an LC or RC low-pass filter and is disposed at the output end of the signal conversion unit 201. It can perform low-pass filtering on the feedback signal output by the signal conversion unit 201 to remove the high-frequency component from the feedback signal, thereby further improving reliability of the feedback signal.

Optionally, continuing with FIG. 4, the primary side circuit of the push-pull switching power 101 is powered by a second power supply end v2. Voltages provided by the first power supply end v1 and the second power supply end v2 are equal or proportionally related.

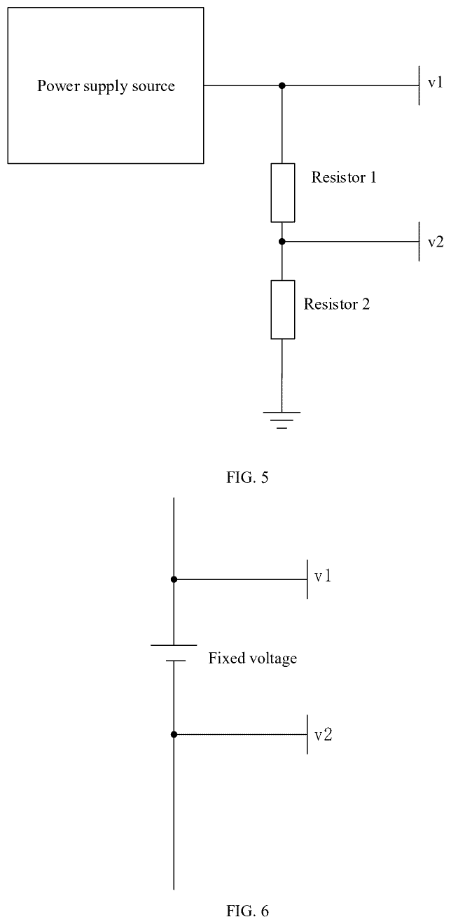

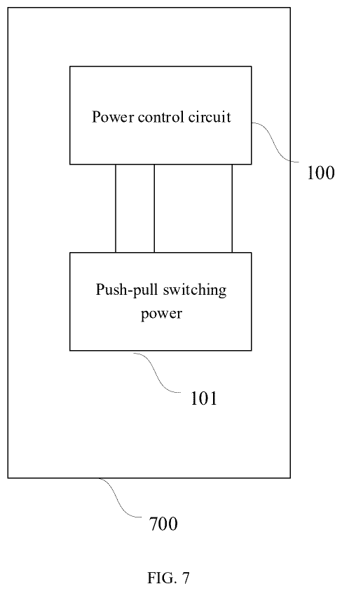

Specifically, the first power supply end v1 is a power supply end that supplies power to the signal conversion unit 201 and is connected to the signal conversion unit 201. The second power supply end v2 refers to an end that supplies power to primary-side windings of the push-pull switching power 101. There may be provided with two primary-side windings. First ends of the two primary-side windings 302 are respectively connected to the second power supply end v2, and second ends of the two primary-side windings 302 are connected to one end of their corresponding switching tube. The first power supply end v1 and the second power supply end v2 may be directly connected to a same end of a same power supply source to achieve an equal voltage provided by the first power supply end and the second power supply end. The first power supply end v1 and the second power supply end v2 may also be connected to the same power supply source in different methods to achieve a certain positive correlation or positive proportional relationship between the power supply voltages of the two ends. FIG. 5 is a schematic diagram illustrating a connection relationship between a first power supply end, a second power supply end, and a power supply source provided in an embodiment of the present disclosure, where the first power supply end v1 is directly connected to one end of the power supply source, while the second power supply end v2 is indirectly connected to the one end of the power supply source via a resistor 1, and vice versa. FIG. 6 is a schematic diagram illustrating another connection relationship between a first power supply end, a second power supply end, and a power supply source provided in an embodiment of the present disclosure, where the power supply source has a fixed voltage, and the first power supply end v1 and the second power supply end v2 are respectively connected to positive and negative electrodes of the power supply source. Referring to FIG. 5 and FIG. 6, both connection methods can achieve a proportional relationship between the voltages provided by the first power supply end v1 and the second power supply end v2, thereby expanding an available voltage range of the second power supply end v2. In addition, continuing with reference to FIG. 4, an end that supplies power to the control module 102 can be defined as a third power supply end v3. The first power supply end v1, the second power supply end v2, and the third power supply end v3 can either be connected together for synchronized power supply or be different ends for independent power supply. The above power supply source can supply power to the feedback module 103 and the primary-side windings of the push-pull switching power 101 through the first power supply end v1 and the second power supply end v2, respectively.

An embodiment of the present disclosure further provides a power supply device. FIG. 7 is a schematic structural diagram illustrating a power supply device provided in an embodiment of the present disclosure. On the basis of the aforementioned embodiments and with reference to FIG. 7, a power supply device 700 includes the power control circuit 100 and the push-pull switching power 101 according to any of the aforementioned embodiments.

The power control circuit and the power supply device provided in the embodiments of the present disclosure are provided with a feedback module and a control module. A first end of the feedback module is connected to a primary side circuit of a push-pull switching power, a second end of the feedback module is connected to the control module, and the feedback module is configured to generate a corresponding feedback signal according to an electrical signal of the primary side circuit of the push-pull switching power. The control module is respectively connected to the control ends of two switching tubes in the primary side circuit of the push-pull switching power, and the control module is configured to control on-off states of the two switching tubes according to a preset power voltage and the feedback signal, so as to adjust output electrical signals of power output channels, achieving the closed-loop feedback control of the push-pull switching power. A feedback signal collection end is disposed in the primary side circuit of the push-pull switching power. This feedback configuration avoids affecting output voltages of the power output channels and a situation of inconsistent voltages in multiple channels, improving the power supply quality of the power without increasing circuit costs and circuit complexity.

The above specific implementations do not constitute a limitation on the scope of protection of the present disclosure. It should be understood by those skilled in the art that various modifications, combinations, sub-combinations, and substitutions can be made according to design requirements and other factors. Any modifications, equivalent substitutions, improvements, etc. made within the spirit and principles of the present disclosure shall all be included within the scope of protection of the present disclosure.

1. A power control circuit, applied to control a push-pull switching power, wherein a secondary side circuit of the push-pull switching power is provided with a plurality of power output channels; and
the power control circuit comprises: a feedback module and a control module,
wherein a first end of the feedback module is connected to a primary side circuit of the push-pull switching power, a second end of the feedback module is connected to the control module, and the feedback module is configured to generate a corresponding feedback signal according to an electrical signal of the primary side circuit of the push-pull switching power; and
the control module is respectively connected to control ends of two switching tubes in the primary side circuit of the push-pull switching power, and the control module is configured to control on-off states of the two switching tubes according to a preset power voltage and the feedback signal, so as to adjust output electrical signals of the power output channels.

2. The power control circuit according to claim 1, wherein the electrical signal of the primary side circuit comprises driving signals of the switching tubes;
the first end of the feedback module is connected to a control end of any one switching tube of the two switching tubes in the primary side circuit of the push-pull switching power; and the feedback module is configured to generate a corresponding feedback signal according to a duty cycle of the driving signal of the switching tube from the control module.

3. The power control circuit according to claim 1, wherein the primary side circuit of the push-pull switching power is provided with an auxiliary sampling winding, wherein one end of the auxiliary sampling winding is connected to the first end of the feedback module, and the other end of the auxiliary sampling winding is grounded;
the electrical signal of the primary side circuit comprises an electrical signal of the auxiliary sampling winding; and
the feedback module is configured to determine a duty cycle of a driving signal of a switching tube of the two switching tubes from the control module according to the electrical signal of the auxiliary sampling winding, and further generate a corresponding feedback signal according to the duty cycle.

4. The power control circuit according to claim 1, wherein the feedback module comprises: a signal conversion unit,
wherein an input end of the signal conversion unit is connected to the first end of the feedback module, an output end of the signal conversion unit is connected to the second end of the feedback module, and the signal conversion unit is configured to generate a corresponding feedback signal according to an electrical signal collected by the first end of the feedback module, wherein the feedback signal is a digital signal with a high level of a first preset voltage and a low level of 0.

5. The power control circuit according to claim 4, wherein the feedback module further comprises a voltage division unit, wherein the voltage division unit is disposed between the output end of the signal conversion unit and the second end of the feedback module, and is configured to perform an adjustment operation on the feedback signal, so that the feedback signal meets a voltage requirement of the control module.

6. The power control circuit according to claim 4, wherein the feedback module further comprises a pre-filtering unit, wherein the pre-filtering unit is disposed between the output end of the signal conversion unit and the second end of the feedback module, and is configured to filter the feedback signal to remove a high-frequency component from the feedback signal.

7. The power control circuit according to claim 4, wherein the signal conversion unit comprises an inverter or a logic buffer, wherein a power supply end of the inverter or the logic buffer is connected to a first power supply end, and the inverter or the logic buffer is configured to convert the electrical signal collected by the first end of the feedback module into the digital signal with a high level of the first preset voltage and a low level of 0, wherein the first preset voltage is provided by the first power supply end.

8. The power control circuit according to claim 7, wherein the primary side circuit of the push-pull switching power supply is powered by a second power supply end; and
voltages provided by the first power supply end and the second power supply end are equal or proportionally related.

9. The power control circuit according to claim 8, wherein the first power supply end and the second power supply end are directly connected to a same end of a same power supply source to achieve an equal voltage provided by the first power supply end and the second power supply end.

10. The power control circuit according to claim 8, wherein the first power supply end is directly connected to one end of a power supply source, and the second power supply end is indirectly connected to the one end of the power supply source via a resistor to achieve a proportional relationship between voltages provided by the first power supply end and the second power supply end.

11. The power control circuit according to claim 8, wherein the first power supply end and the second power supply end are respectively connected to positive and negative electrodes of a power supply source with a fixed voltage to achieve a proportional relationship between voltages provided by the first power supply end and the second power supply end.

12. The power control circuit according to claim 1, wherein the power control circuit further comprises a grounding resistor and an anti-reverse diode, wherein one end of the grounding resistor is connected to the first end of the feedback module, and the other end of the grounding resistor is grounded, and the anti-reverse diode is disposed between the first end of the feedback module and the primary side circuit of the push-pull switching power.

13. The power control circuit according to claim 3, wherein the power control circuit further comprises a grounding resistor and an anti-reverse diode, wherein one end of the grounding resistor is connected to the first end of the feedback module, and the other end of the grounding resistor is grounded, and the anti-reverse diode is disposed between the first end of the feedback module and the auxiliary sampling winding.

14. The power control circuit according to claim 1, wherein the control module comprises a driver chip and/or a pulse width modulation control chip.

15. The power control circuit according to claim 2, wherein the control module comprises a driver chip and/or a pulse width modulation control chip.

16. The power control circuit according to claim 3, wherein the control module comprises a driver chip and/or a pulse width modulation control chip.

17. The power control circuit according to claim 4, wherein the control module comprises a driver chip and/or a pulse width modulation control chip.

18. The power control circuit according to claim 5, wherein the control module comprises a driver chip and/or a pulse width modulation control chip.

19. The power control circuit according to claim 6, wherein the control module comprises a driver chip and/or a pulse width modulation control chip.

20. A power supply device, comprising a power control circuit and a push-pull switching power, wherein the power control circuit is applied to control the push-pull switching power and comprises a feedback module and a control module,
wherein a first end of the feedback module is connected to a primary side circuit of the push-pull switching power, a second end of the feedback module is connected to the control module, and the feedback module is configured to generate a corresponding feedback signal according to an electrical signal of the primary side circuit of the push-pull switching power; and the control module is respectively connected to control ends of two switching tubes in the primary side circuit of the push-pull switching power, and is configured to control on-off states of the two switching tubes according to a preset power voltage and the feedback signal, so as to adjust output electrical signals of power output channels provided in a secondary side circuit of the push-pull switching power.
